(19) United States
(12) Patent Application Publication
(10) Pub. No.: US 2026/0343466 A1
(43) Pub. Date: Oct. 29, 2026

(54) Methods, Apparatus and Computer-Readable Media for Determining a Timing Advance in a Non-Terrestrial Network

(71) Applicant: TELEFONAKTIEBOLAGET LM ERICSSON (PUBL), Stockholm (SE)

(72) Inventors: Johan Rune, Lidingö (SE); Robert Karlsson, Sundbyberg (SE); Ignacio Javier Pascual Pelayo, Stockholm (SE); Talha Khan, Santa Clara, CA (US); Emre Yavuz, Stockholm (SE)

(21) Appl. No.: 19/099,204

(22) PCT Filed: Aug. 9, 2023
(86) PCT No.: PCT/SE2023/050799

§ 371 Date: Jan. 28, 2025

Related U.S. Application Data
(60) Provisional application No. 63/396,345, filed on Aug. 9, 2022.

(51) Int. Cl. H04W 64/00; H04W 56/00; H04W 84/06

(52) U.S. Cl. CPC H04W 64/00; H04W 56/0045; H04W 84/06

(57) ABSTRACT

A method is performed by a user equipment (UE) in a non-terrestrial network (NTN) for determining a timing advance. The method comprises receiving, from a network node in the NTN, a first message comprising one or more instructions configuring the UE to perform positioning measurements. The positioning measurements indicate a location of the UE for use in determining the timing advance.

### TECHNICAL FIELD

Embodiments of the present disclosure relate to methods, apparatus and computer-readable media relating to wireless networks, and particularly to the determination of a timing advance in non-terrestrial networks.

### BACKGROUND

### General Background on 3GPP Technology

In the Third Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since Release 13 Narrowband Internet of Things (NB-IoT) and LTE Machine Type Communication (MTC) (LTE-M) are part of the LTE specifications and provide connectivity to massive machine type communications (mMTC) services.

In 3GPP Release 15, the first release of the 5G system (5GS) was specified. This is a new generation radio access technology intended to serve use cases such as enhanced mobile broadband (eMBB), ultra-reliable and low latency communication (URLLC) and mMTC services. 5G includes the New Radio (NR) access stratum interface and the 5G Core Network (5GC). The NR physical and higher layers are reusing parts of the LTE specification, and additional components are introduced when motivated by the new use cases. One such component is the introduction of a sophisticated framework for beam forming and beam management to extend the support of the 3GPP technologies to a frequency range going beyond 6 GHz.

In Release 15, 3GPP also started the work to prepare NR for operation in a Non-Terrestrial Network (NTN). The work was performed within the Study Item “NR to support Non-Terrestrial Networks” and resulted in 3GPP TR 38.811 (“Study on New Radio (NR) to support Non-Terrestrial Networks”). In Release 16 the work to prepare NR for operation in a Non-Terrestrial Network continued with the Study Item “Solutions for NR to support Non-Terrestrial Network” which resulted in 3GPP TR 38.821 (“Solutions for NR to support Non-Terrestrial Networks”).

The Release 16 study item resulted in a Work Item being agreed for NR in Release 17, “Solutions for NR to support non-terrestrial networks (NTN)”, which is described in the Work Item Description RP-193234 (RP-193234, 3GPP Work Item Description, “Solutions for NR to support non-terrestrial networks (NTN)”).

### NB-IoT

At the 3GPP RAN #70 meeting, a new Release 13 work item named Narrowband IoT (NB-IoT) was approved. The objective of the new Internet of Things (IoT) related work item approved for release 13 was to specify a radio access for cellular IoT that addresses improved indoor coverage, support for massive number of low throughput devices, not sensitive to delay, ultra-low device cost, low device power consumption and (optimized) network architecture.

NB-IoT can be described as a narrowband version of LTE. Similar to eMTC, NB-IoT makes use of increased acquisition times and time repetitions to extend the system coverage. The repetitions can be seen as a third level of retransmissions added at the physical layer as a complement to those at Medium Access Control (MAC) Hybrid Automatic Repeat Request (ARQ) (HARQ) and Radio Link Control (RLC) ARQ. An NB-IoT downlink carrier is defined by 12 Orthogonal Frequency-Division Multiplexing (OFDM) sub-carriers, each of 15 kHz, giving a total baseband bandwidth of 180 kHz. When multiple carriers are configured, several 180 kHz carriers can be used, e.g., for increasing the system capacity, inter-cell interference coordination, load balancing, etc. This design gives NB-IoT a high deployment flexibility.

NB-IoT supports 3 different deployment scenarios or modes of operation:
1. ‘Stand-alone operation’, utilizing for example the spectrum currently being used by Global System for Mobile Communication (GSM) EDGE Radio Access Network (GERAN) systems as a replacement of one or more GSM carriers. In principle it operates on any carrier frequency which is neither within the carrier of another system nor within the guard band of another system's operating carrier. The other system can be another NB-IoT operation or any other Radio Access Technology (RAT) e.g. LTE.
2. ‘Guard band operation’, utilizing the unused resource blocks within an LTE carrier's guard band. The term guard band may also interchangeably be called guard bandwidth. As an example, in case of LTE bandwidth of 20 MHz (i.e. Bw1=20 MHz or 100 RBs), the guard band operation of NB-IoT can place anywhere outside the central 18 MHz but within 20 MHz LTE bandwidth.
3. ‘In-band operation’, utilizing resource blocks within a normal LTE carrier. The in-band operation may also interchangeably be called in-bandwidth operation. More generally, the operation of one RAT within the bandwidth of another RAT is also called in-band operation. As an example, in a LTE bandwidth of 50 Resource Blocks (RBs) (i.e. Bw1=10 MHz or 50 RBs), NB-IoT operation over one RB within the 50 RBs is called in-band operation.

In NB-IoT, anchor and non-anchor carriers are defined. On an anchor carrier the User Equipment (UE) assumes that anchor specific signals including Narrowband Primary Synchronization Sequence (NPSS)/Narrowband Secondary Synchronization Sequence (NSSS)/Narrowband Physical Broadcast Channel (NPBCH)/Narrowband System Information Block (SIB-NB) are transmitted in the downlink. On a non-anchor carrier, the UE does not assume that NPSS/NSSS/NPBCH/SIB-NB are transmitted in downlink. The anchor carrier is transmitted on at least subframes #0, #4, #5 in every frame and subframe #9 in every other frame. Additional Downlink (DL) subframes in a frame can also be configured on the anchor carrier by means of a DL bit map. The anchor carriers transmitting NPBCH/SIB-NB contains also Narrowband Reference Signal (NRS). The non-anchor carrier contains NRS during certain occasions and UE specific signals such as Narrowband Physical Downlink Control Channel (NPDCCH) and Narrowband Physical Downlink Shared Channel (NPDSCH). NRS, NPDCCH and NPDSCH are also transmitted on the anchor carrier. The resources for a non-anchor carrier are configured by the network, i.e. the eNB. The non-anchor carrier can be transmitted in any subframe as indicated by a DL bit map. For example, the eNB signals a DL bit map of DL subframes using a Radio Resource Control (RRC) message (DL-Bitmap-NB) which are configured as a non-anchor carrier. The anchor carrier and/or non-anchor carrier may typically be operated by the same network node (eNB) e.g. by the serving cell. But the anchor carrier and/or non-anchor carrier may also be operated by different network nodes (i.e. different eNBs).

### Satellite Communications

There is an ongoing resurgence of satellite communications. Several plans for satellite networks have been announced in the past few years. The target services vary, from backhaul and fixed wireless, to transportation, to outdoor mobile, to IoT. Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work. In 3GPP release 15, 3GPP started the work to prepare NR for operation in a Non-Terrestrial Network (NTN). The work was performed within the study item “NR to support Non-Terrestrial Networks” and resulted in 3GPP TR 38.811 (“Study on New Radio (NR) to support Non-Terrestrial Networks”). In 3GPP release 16, the work to prepare NR for operation in an NTN network continued with the study item “Solutions for NR to support Non-Terrestrial Network”, which has been captured in 3GPP TR 38.821 (“Solutions for NR to support Non-Terrestrial Networks”). In parallel the interest to adapt NB-IoT and LTE-M for operation in NTN is growing. As a consequence, 3GPP release 17 contains both a work item on NR NTN (RP-193234, 3GPP Work Item Description, “Solutions for NR to support non-terrestrial networks (NTN)”) and a study item and work item on NB-IoT and LTE-M support for NTN (RP-193235, “Study on NB-Iot/eMTC support for Non-Terrestrial Network”, and RP-211601, “NB-IoT/eMTC support for Non-terrestrial Networks (NTN), RAN #92-e, June 2021”).

### Characteristics

A satellite radio access network usually includes the following components:
A satellite that refers to a space-borne platform.
An earth-based gateway that connects the satellite to a base station or a core network, depending on the choice of architecture.
A feeder link that refers to the link between a gateway and a satellite.
An access link, or service link, that refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 1,500-35,786 km, with orbital periods, P_{MEO}, in the range 2 hours<P_{MEO}<24 hours. MEO and LEO are also known as Non-Geo Synchronous Orbit (NGSO) type of satellite.
GEO: height at about 35,786 km, with an orbital period of 24 hours. Also known as a Geo Synchronous Orbit (GSO) type of satellite.

Two basic architectures can be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the UE
Regenerative payload. The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP release 17, only the transparent payload architecture is considered.

FIG. 1 shows an example architecture of a satellite network with bent pipe transponders (i.e., the transparent payload architecture). The architecture comprises a satellite 102, a device 104, a Gateway 106, and a Base Station (BS) 108. The gNB may be integrated in the gateway or connected to the gateway via a terrestrial connection (wire, optic fiber, wireless link).

The significant orbit height means that satellite systems are characterized by a path loss that is significantly higher than what is expected in terrestrial networks. To overcome the pathloss it is often required that the access and feeder links are operated in line-of-sight conditions, and that the UE is equipped with an antenna offering high beam directivity.

A communication satellite typically generates several beams over a given area. The footprint of a beam is usually in an elliptic shape, which has been traditionally considered as a cell (but a cell consisting of multiple beams is not precluded). The footprint of a beam is also often referred to as a spotbeam. The spotbeam may move over the earth surface with the satellite movement (and the earth's rotation) or may be earth fixed with some beam pointing mechanism used by the satellite to compensate for its motion. The size of a spotbeam depends on the system design and may range from tens of kilometers to a few thousands of kilometers.

The NTN beam may in comparison to the beams observed in a terrestrial network provide a very wide footprint and may cover an area outside of the area defined by the served cell. Beam covering adjacent cells may overlap and cause significant levels of intercell interference, resulting from the slow decrease of the signal strength in the outwards radial direction. This is due in part to the high elevation angle and long distance to the network-side (satellite-borne) transceiver, which, compared with terrestrial cells, results in a comparatively small relative difference between the distance from the cell center to the satellite and the distance from a point at the cell edge to the satellite. To overcome the large levels of interference, a typical approach in NTN is to configure different cells with different carrier frequencies and polarization modes.

Three types of beams or cells are supported in NTN:
Earth-fixed beams/cells: provisioned by beam(s) continuously covering the same geographical areas all the time (e.g., in the case of GEO satellites).
Quasi-earth-fixed beams/cells: provisioned by beam(s) covering one geographic area for a limited period and a different geographic area during another period (e.g., in the case of Non-Geostationary Orbit (NGSO) satellites generating steerable beams).
Earth-moving beams/cells: provisioned by beam(s) whose coverage area slides over the earth surface (e.g., in the case of NGSO satellites generating fixed or non-steerable beams).

Throughout this disclosure, the terms beam and cell are used interchangeably, unless explicitly noted otherwise.

Of the three above cell types, quasi-earth-fixed cells and moving cells seem to be the ones most promising for actual deployment. In the case of moving cells, each cell (the footprint of its beam(s)) moves across the surface of the earth as its serving satellite moves along its orbit. In the case of quasi-earth-fixed cells, the cell area (as the name implies) remains fixed to the same geographical area, regardless of satellite movements. To enable this, a serving satellite has means for dynamically directing its beam(s), so that the same area of the earth is covered despite the satellite's movement. However, since the satellites orbit around the earth, the same satellite may only be able to cover the same area on the earth for a limited time, unless the satellite is in a geostationary orbit (and note that LEO satellites have the most traction in the satellite communication industry). This means that different satellites may have the task of covering a certain geographical cell area at different time periods. When this task is switched from one satellite to another, this in principle means that one cell is replaced by another, although covering the same area. As a consequence, all UEs connected in the old cell (i.e., UEs in RRC_CONNECTED state) may have to be handed over (or otherwise moved, e.g. using RRC connection reestablishment) from the old to the new cell, and all UEs camping on the old cell (i.e., UEs in RRC_IDLE or RRC_INACTIVE state) may have to perform cell reselection to the new cell.

In terms of such cell switches there are two alternative principles: 1) hard switch; and 2) soft switch. With hard switch, there is an instantaneous switch from the old to the new cell, i.e., the new cell appears at the same time as the old cell disappears. This makes completely seamless (i.e., interruption free) handover in practice impossible and creates a situation which may lead to overload of the access resources in the new cell, due to potential access attempt peaks when many UEs try to access the new cell right after the cell switch. With soft switch there is a time period during which the new and the old cell coexist (i.e. overlap), covering the same geographical area. This coexistence/overlap period allows some time for connected UEs to be handed over and for camping UEs to reselect to the new cell, which facilitates distribution of the access load in the new cell and thereby also provides better conditions for handovers with shorter interruption time. Soft switch is likely to be the most prevalent cell switch principle in quasi-earth-fixed cell deployments.

### Ephemeris Data

Ephemeris data (sometimes referred to as just “ephemeris”) is data that allows a UE (or other entity) to determine a satellite's position and velocity, i.e., the ephemeris data contains parameters related to the satellite's orbit. There are several different formats defined for ephemeris data.

In TR 38.821 (“Solutions for NR to support Non-Terrestrial Networks”), it has been captured that ephemeris data should be provided to the UE, for example to assist with pointing a directional antenna (or an antenna beam) towards the satellite, and to calculate a correct Timing Advance (TA) as discussed below (see “Consequences of long propagation delay/RTT on the timing advance (TA)”) and Doppler shift. In NR NTN and IoT NTN, ephemeris data may be broadcast in the system information (SI) in each cell, included in an NTN specific System Information Block (SIB), (labeled SIB19 in NR NTN and SIB31 IoT NTN).

A satellite orbit can be fully described using 6 parameters. Exactly which set of parameters is chosen can be decided by the user; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch time t determines a reference time (e.g. the time when the satellites moves through periapsis). This set of parameters is illustrated in Figure FIG. 2.

FIG. 2 shows orbital elements illustrated by parameters included in one ephemeris data format.

As an example of a different parametrization, the Two-Line Element Sets (TLEs) use mean motion n and mean anomaly M instead of a and t. A completely different set of parameters is the position and velocity vector (x, y, z, vₓ, v_{y}, v_{z}) of a satellite. These are sometimes called orbital state vectors. They can be derived from the orbital elements and vice versa, since the information they contain is equivalent. All these formats (and many others) are possible choices for the format of ephemeris data to be used in NTN.

An aspect discussed during the 3GPP study item and captured in 3GPP TR 38.821 (“Solutions for NR to support Non-Terrestrial Networks”), is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently. For example, the update frequency depends on the satellite and its orbit and ranges from weekly to multiple times a day for satellites on very low orbits which are exposed to strong atmospheric drag and may need to perform correctional maneuvers often. Even more frequent updates may be used in NR NTN (and IoT NTN) to allow the UE to determine/predict the satellite's position (and velocity) accurately enough to satisfy the requirements in NTN, e.g., to enable a UE to calculate an accurate enough UE-specific TA, as discussed below (see “Consequences of long propagation delay/RTT on the timing advance (TA)”).

### Global Navigation Satellite System (GNSS)

A Global Navigation Satellite System (GNSS) comprises a set of satellites orbiting the earth in orbits crossing each other, such that the orbits are distributed around the globe. The satellites transmit signals and data that allows a receiving device on earth to accurately determine time and frequency references and, maybe most importantly, accurately determine its position, provided that signals are received from a sufficient number of satellites (e.g., four). The position accuracy may typically be in the range of a few meters, but using averaging over multiple measurements, a stationary device may achieve much better accuracy.

A well-known example of a GNSS is the American Global Positioning System (GPS). Other examples are the Russian Global Navigation Satellite System (GLONASS), the Chinese BeiDou Navigation Satellite System and the European Galileo.

The transmissions from GNSS satellites include signals that a receiving device uses to determine the distance to the satellite. By receiving such signals from multiple satellites, the device can determine its position. However, this requires that the device also knows the positions of the satellites. To enable this, the GNSS satellites also transmit data about their own orbits (from which position at a certain time can be derived). In GPS, such information is referred to as ephemeris data and almanac data (or sometimes lumped together under the term navigation information).

The time required to perform a GNSS measurement, e.g. GPS measurement, may vary widely, depending on the circumstances, mainly depending on the status of the ephemeris and almanac data the measuring devices has previously acquired (if any). In the worst case, a GPS measurement can take several minutes. GPS is using a bit rate of 50 bps for transmitting its navigation information. The transmission of the GPS date, time and ephemeris information takes 90 seconds. Acquiring the GPS almanac containing orbital information for all satellites in the GPS constellation takes more than 10 minutes. If a UE already possesses this information the synchronization to the GPS signal for acquiring the UE position and Coordinated Universal Time (UTC) is a significantly faster procedure. The state of a GNSS receiver with regards to the above, may be classified as cold, warm or hot state, where the time required to perform a GNSS measurement to determine a position is the longest in cold state, and the shortest in hot state.

A relevant note on terminology is that a position determined based on a GNSS measurement, or the act of determining a position based on a GNSS measurement, is also referred to as a “position fix”.

### 3GPP Dependence of GNSS for NR NTN and IoT NTN

To handle the timing and frequency synchronization in an NR or LTE based NTN, a promising technique is to equip each device with a Global Navigation Satellite System (GNSS) receiver. The GNSS receiver allows a device to estimate its geographical position. In one example, an NTN gNB carried by a satellite, or communicating via a satellite, broadcasts its ephemeris data (i.e., data that informs the UE about the satellite's position, velocity, and orbit) to a GNSS equipped UE. The UE can then determine the propagation delay, the delay variation rate, the Doppler shift, and its variation rate based on its own location (obtained through GNSS measurements) and the satellite location and movement (derived from the ephemeris data).

The GNSS receiver also allows a device to determine a time reference (e.g. in terms of Coordinated Universal Time (UTC)) and frequency reference. This can also be used to handle the timing and frequency synchronization in an NR or LTE based NTN. In a second example an NTN gNB carried by a satellite, or communicating via a satellite, broadcasts its timing (e.g., in terms of a Coordinated Universal Time (UTC) timestamp) to a GNSS equipped UE. The UE can then determine the propagation delay, the delay variation rate, the Doppler shift, and its variation rate based on its time/frequency reference (obtained through GNSS measurements) and the satellite timing and transmit frequency.

The UE may use this knowledge to compensate its uplink (UL) transmissions for the propagation delay and Doppler effect.

The 3GPP release 17 SID on NB-IoT and LTE-M for NTN supports this observation (RP-193235, “Study on NB-Iot/eMTC support for Non-Terrestrial Network”):

“GNSS capability in the UE is taken as a working assumption in this study for both NB-IoT and eMTC devices. With this assumption, UE can estimate and pre-compensate timing and frequency offset with sufficient accuracy for UL transmission. Simultaneous GNSS and NTN NB-IoT/eMTC operation is not assumed.”

Furthermore, in the NR NTN work item and IoT NTN work item for 3GPP release 17, GNSS capability is assumed, i.e., it is assumed that an NR NTN capable or IoT NTN capable UE also is GNSS capable and GNSS measurements at the UEs are important for the operation of the NTN, e.g., the UEs are expected to compensate their UL transmissions for the propagation delay and Doppler effect. In particular, the UE uses knowledge of its location and broadcast information about the satellite's position (i.e. ephemeris data) to calculate the UE-satellite Round Trip Time (RTT), which is then used in UE autonomous calculation of a Timing Advance (TA), as discussed below (see “Consequences of long propagation delay/RTT on the timing advance (TA)”). However, an IoT NTN UE is not expected to be able to perform a GNSS measurement while receiving transmissions from network at the same time.

When using GNSS measurements for purposes related to the operation and performance of an NR NTN or IoT NTN, the GNSS measurement must be fresh enough to be reliable. For this reason, the notion of a GNSS validity timer has been introduced, which governs the maximum age UE location information may have when used in such operations (e.g. for calculation of a timing advance). A suitable value for this maximum age may depend on the UE's implementation, and therefore the GNSS validity timer is a UE implementation specific mechanism. However, the standard specifications include means by which the UE can inform the network (i.e. the serving gNB in NR NTN and the serving eNB in IoT NTN) of the remaining time of the UE's currently running GNSS validity timer.

### Consequences of Long Propagation Delay/RTT on the Timing Advance (TA)

Propagation delay is an important aspect of satellite communications its expected impact in NTN is different from the impacts of propagation delay in a terrestrial mobile system. For a bent pipe satellite network, the UE-gNB round-trip delay may, depending on the orbit height, range from a few or tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and thus the elevation angle ε seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite may need to be considered as well, unless the base station corrects for that.

TABLE 1
Propagation delay for different orbital heights and elevation angles.

| | | | One-way | Propagation |
|---|---|---|---|---|
| Orbital | Elevation | Distance | propagation | delay |
| height | angle | UE <-> satellite | delay | difference |
| 600 km | 90° | 600 km | 2.0 ms | — |
| | 30° | 1075 km | 3.6 ms | 1.6 ms |
| | 10° | 1932 km | 6.4 ms | 4.4 ms |
| 1200 km | 90° | 1200 km | 4.0 ms | — |
| | 30° | 1999 km | 6.7 ms | 2.7 ms |
| | 10° | 3131 km | 10.4 ms | 6.4 ms |
| 35786 km | 90° | 35786 km | 119.4 ms | — |
| | 30° | 38609 km | 128.8 ms | 9.4 ms |
| | 10° | 40581 km | 135.4 ms | 16.0 ms |

The propagation delay may also be highly variable due to the high velocity of the LEO and MEO satellites and change in the order of 10-100 μs every second, depending on the orbit altitude and satellite velocity.

The long propagation delays in NTN have many consequences, one of which being that large Timing Advance (TA) values may have to be used (where a TA is the time a UE advances its UL transmission in relation to the corresponding frame, slot and symbol in the DL to achieve alignment between the UL and the DL frame/slot/symbol structure at an UL/DL alignment reference point, which typically is the gNB). In addition, due to the fast movement of the satellite (excluding GEO satellites), the TA may continuously change and may do so quite rapidly. 3GPP has dealt with these circumstances through a combination of new parameters and introduction of the principle of UE autonomous adaptation of the TA.

Typically, the network wants the UL and DL to be aligned at the gNB receiver, which means that the TA should be equal to the UE-gNB RTT. The UE-gNB RTT can be divided into two parts: the UE-satellite RTT (i.e., the service link RTT) and the gNB-satellite RTT (which is equal to the feeder link RTT assuming that the Gateway (GW) and the gNB are collocated). The satellite-gNB RTT is equal for all locations in the cell and thus the same for all UEs in the cell, whereas the UE-satellite RTT depends on the UE's location and thus is UE specific.

To take care of the part of the TA that is common for all UEs in the cell, the satellite broadcasts (in the system information, in a new SIB with NTN specific data (SIB19 in NR NTN and SIB31 in IoT NTN)) so-called Common TA information, consisting of a Common TA value, the first time derivative of the Common TA value (denoted as “drift”) and the second time derivative of the Common TA value (denoted as “drift variation”). The UE specific part of the TA, i.e., the UE-satellite RTT is left to the UE to autonomously calculate. To do this, the UE obtains its own location and the satellite position. The UE can obtain its own location e.g., using GNSS measurements, and the satellite's position (as well as its velocity) can be derived from the ephemeris data broadcast by the gNB (in the same SIB as the Common TA parameters). The ephemeris data and the Common TA parameters are nominally valid at a so-called epoch time, which is also indicated in the same SIB. Based on the ephemeris data, the UE can predict the satellite's position a certain time into the future, and the first and second time derivatives (i.e., the drift and drift variation parameters) of the Common TA allows the UE to calculate how the Common TA value changes with time. Furthermore, the broadcast ephemeris data and Common TA parameters have a limited validity time, which is also indicated in the same SIB. The ephemeris data and Common TA parameters the UE uses when calculating the UE specific TA should be valid, i.e. their validity time must not have expired. The same goes for the UE location information, typically based on a GNSS measurement, the UE uses in the TA calculation (in particular to calculate the UE-satellite RTT).

3GPP has also introduced support for the possibility to place the UL/DL alignment reference point at some other place than in the gNB. This support comes in the form of a parameter denoted as Kmac. The Kmac parameter takes care of the RTT between the gNB and the chosen UL/DL alignment reference point. Hence, Kmac=0 means that the UL/DL alignment reference point is located in the gNB, while other Kmac values may place the UL/DL alignment reference point somewhere between the gNB and the satellite. Kmac is included in the same SIB as the other above mentioned NTN specific configuration parameters. Broadcast of Kmac is optional and absence of a Kmac parameter in the concerned SIB implicitly means that Kmac=0 should be used.

When calculating the UE specific TA, the UE may only use the Common TA parameters, the ephemeris data and its own location, i.e. Kmac is not needed for this calculation. However, the UE may need to know Kmac for other purposes, so that it can adapt certain timers to the UE-gNB RTT.

For Non-Terrestrial Networks using 3GPP technology, in particular 5G/NR, the long propagation delay means that the timing advance (TA) the UE uses for its uplink transmissions is important and may have to be much greater than in terrestrial networks in order for the uplink and downlink to be time-aligned at the gNB (or at another point if Kmac>0), as is the case in NR and LTE. One of the purposes of the random access (RA) procedure is to provide the UE with a valid TA. However, even the random access preamble (i.e. the initial message from the UE in the random access procedure) may have to be transmitted with a timing advance to allow a reasonable size of the RA preamble reception window in the gNB (and to ensure that the cyclic shift of the preamble's Zadoff-Chu sequence cannot be so large that it makes the Zadoff-Chu sequence, and thus the preamble, appear as another Zadoff Chu sequence, and thus another preamble, based on the same Zadoff-Chu root sequence), but this TA does not have to be as accurate as the TA the UE subsequently uses for other uplink transmissions, where the TA should be accurate enough to keep the timing error smaller than the Cyclic Prefix (CP).

In conjunction with the random access procedure, the gNB provides the UE with an accurate (i.e. fine-adjusted) TA in the Random Access Response (RAR) message (in 4-step RA) or MsgB (in 2-step RA), based on the time of reception of the random access preamble. In terrestrial NR, the gNB can subsequently adjust the UE's TA using a Timing Advance Command MAC Control Element (CE) (or an Absolute Timing Advance Command MAC CE), based on the timing of receptions of uplink transmissions from the UE. A goal with such network control of the UE's timing advance is typically to keep the time error of the UE's uplink transmissions at the gNB's receiver within the cyclic prefix (which is required for correct decoding of the uplink transmissions, e.g., on the Physical Uplink Shared Channel (PUSCH) and the Physical Uplink Control Channel (PUCCH)). The timing advance control framework for terrestrial NR and LTE also includes a time alignment timer that the gNB configures the UE with. The time alignment timer is restarted every time the gNB adjusts the UE's TA and if the time alignment timer expires, the UE is not allowed to transmit in the uplink without a prior random access procedure (which serves the purpose to provide the UE with a valid timing advance). These rules associated with the time alignment timer may assumedly be the same in NTN, but the relation and/or interaction between the time alignment timer and certain NTN specific functionality, e.g. related to GNSS measurements, may impact the role of the time alignment timer in NTN. For NTN, 3GPP has also agreed that in addition to the gNB's control of the UE's TA, the UE is allowed to autonomously update its TA based on estimation of changes in the UE-gNB RTT (using the UE's location and broadcast parameters related to the satellite orbit and the feeder link RTT, as previously described).

The long propagation delays and the resulting large TA a UE may have to use also impacts the scheduling of uplink transmissions. Specifically, the network may have to take the large TA into account when it determines the delay to be used between an UL grant (i.e. a Downlink Control Information (DCI) on the Physical Downlink Control Channel (PDCCH) allocating uplink transmission resources for the UE to transmit on) and the uplink transmission resources the UL grant allocates. For this purpose, a new parameter denoted as “K_{offset}” (or “Koffset” or “K_offset”) is introduced, which is added to the legacy delay, e.g. added to the legacy delay parameter K₂ (or K2) contained in the UL grant in NR NTN. The K_{offset} parameter comes in two forms: the cell-specific K_{offset}, which is broadcast in the system information and which is common for all UEs in the cell, and the UE-specific K_{offset}, which the network optionally configures for each UE. Note that configuration of a UE-specific K_{offset} value is optional, and when it is absent, the cell-specific K_{offset} value applies. To facilitate for the network to determine a suitable UE-specific K_{offset} value for a certain UE, a mechanism for TA reporting is introduced in NTN, whereby the UE can report its current TA to the network (where the granularity of the reported TA value is one slot).

### NTN-Specific Information in the System Information

Due to the special operating conditions in a Non-Terrestrial Network, the system information broadcast in an NTN cell may have to include NTN-specific information. To serve this purpose, a new SIB (SIB19) is introduced in NR NTN which contains NTN-specific information. In IoT NTN, the new SIB31 more or less corresponds to SIB19 in NR NTN.

In 3GPP TS 38.331 version 17.0.0, SIB19 is defined as follows in Abstract Syntax Notation One (ASN.1) code:

```
-- ASN1START
-- TAG-SIB19-START
SIB19-r17 ::= SEQUENCE {
  ntn-Config NTN-Config-r17  OPTIONAL,  -- Need R
  t-Service-r17 INTEGER (0..549755813887) OPTIONAL, --
  Need R
  referenceLocation-r17 ReferenceLocation-r17 OPTIONAL, --
  Need R
  ta-Report-r17 ENUMERATED {enabled} OPTIONAL, -- Need
  R
  lateNonCriticalExtension  OCTET STRING  OPTIONAL,
  ...
}
ReferenceLocation-r17 ::= ENUMERATED { ffs } -- FFS
-- TAG-SIB19-STOP
-- ASN1STOP
```

SIB19 field descriptions

ntn-Config
Provides Ephemeris data, common TA parameters, koffset, validity duration for UL sync
information and epoch time when included in SIB19.
referenceLocation
Reference location of a cell provided via NTN quasi-Earth fixed system. FFS for exact field
description.
ta-Report
Indicates whether UE specific TA reporting is enabled during initial access (see TS 38.321
[3], clause 5.4.8).
t-Service
Indicates the time information on when a cell provided via NTN quasi-Earth fixed system
is going to stop serving the area it is currently covering. The field counts the number of UTC
seconds in 10 ms units since 00:00:00 on Gregorian calendar date 1 Jan., 1900 (midnight
between Sunday, Dec. 31, 1899 and Monday, Jan. 1, 1900).FFS” This field is
excluded when determining changes in system information, i.e. changes of t-Service should
neither result in system information change notifications nor in a modification of valueTag
in SIB1.”

Furthermore, the NTN-Config-r17 IE is defined as follows in ASN.1 code in the same specification:

```
-- ASN1START
-- TAG-NTN-CONFIG-START
NTN-Config-r17 ::= SEQUENCE {
  epoch Time-r17 Epoch Time-r17 OPTIONAL, -- Need R
  ntn-UlSyncValidityDuration-r17 ENUMERATED{s5,  s10,  s15,
    s20, s25, s30, s35,
    s40, s45, s50, s55,
    s60, s120, s180, s240} OPTIONAL, -- Need R
  cellSpecificKoffset-r17 INTEGER(0..1023) OPTIONAL, -- Need R
  kmac-r17 INTEGER(0..512) OPTIONAL, -- Need R
  ta-Info-r17 TAInfo-r17 OPTIONAL, -- Need R
  ntn-PolarizationDL-r17 ENUMERATED {rhcp,lhcp,linear}
OPTIONAL, -- Need R
  ntn-PolarizationUL-r17 ENUMERATED {rhcp,lhcp,linear}
OPTIONAL, -- Need R
  ephemerisInfo-r17 EphemerisInfo-r17 OPTIONAL, -- Need R
  ...
}
Epoch Time-r17 ::= SEQUENCE {
  sfn-r17 INTEGER(0..1023),
  subFrameNR-r17 INTEGER(0..9)
}
TAInfo-r17 ::= SEQUENCE {
  ta-Common-r17 INTEGER(0..66485757),
  ta-CommonDrift-r17 INTEGER(−261935..261935) OPTIONAL,
  -- Need R
  ta-CommonDriftVariant-r17 INTEGER(0..29470) OPTIONAL
  -- Need R
}
-- TAG-NTN-CONFIG-STOP
-- ASN1STOP
```

NTN-Config field descriptions

EphemerisInfo
This field provides satellite ephemeris either in format of position and velocity state vector or
in format of orbital parameters. This field is excluded when determining changes in system
information, i.e. changes of XXX should neither result in system information change
notifications nor in a modification of valueTag in SIB1.
epochTime
Indicate the epoch time for assistance information (i.e. Serving satellite ephemeris in IE
ephemerisInfo and Common TA parameters). When explicitly provided through SIB, or
through dedicated signaling, EpochTime is the starting time of a DL sub-frame, indicated by a
SFN and a sub-frame number signaled together with the assistance information. The reference
point for epoch time of the serving satellite ephemeris and Common TA parameters is the
uplink time synchronization reference point. If this field is absent, the epoch time is the end of
SI window where this SIB19 is scheduled. This field is mandatory present when provided in
dedicated configuration.
cellSpecificKoffset
The CellSpecific_K_offset is a scheduling offset used for the timing relationships that need to
be modified for NTN [see TS 38.2xy]. The unit of K_offset is number of slots for a given
subcarrier spacing of 15 kHz. FFS other SCS.
kmac
K_mac is a scheduling offset provided by network if downlink and uplink frame timing are
not aligned at gNB. It is needed for UE action and assumption on downlink configuration
indicated by a MAC-CE command in PDSCH [see TS 38.2xy]. When UE is not provided by
network with a K_mac value, UE assumes K_mac = 0.
For the reference subcarrier spacing value for the unit of K_mac in FR1 a value of 15 kHz is
used. The unit of K mac is number of slots for a given subcarrier spacing. FFS other SCS.
ntn-PolarizationDL
If present, this parameter indicates polarization information for Downlink transmission on
service link: including Right hand, Left hand circular polarizations (RHCP, LHCP) and Linear
polarization.
ntn-PolarizationUL
If present, this parameter indicates Polarization information for Uplink service link.
If not present and ntnPolarizationDL is present, UE assumes a same polarization for UL and
DL.
ntn-UlSyncValidityDuration
A validity duration configured by the network for uplink synchronization assistance
information (i.e. Serving satellite ephemeris and Common TA parameters) which indicates the
maximum time during which the UE can apply assistance information without having acquired
new assistance information.
The unit of ntn-UlSyncValidityDuration is second. This parameter applies to both connected
and idle mode UEs.
ta-Common
TACommon is a network-controlled common timing advanced value and it may include any
timing offset considered necessary by the network. TACommon with value of 0 is supported.
The granularity of TACommon is 4.07 × 10\hat{ }(−3) μs. Values are given in unit of corresponding
granularity. This field is excluded when determining changes in system information, i.e.
changes of XXX should neither result in system information change notifications nor in a
modification of valueTag in SIB1.”
taCommonDrift
Indicate drift rate of the common TA. The granularity of TACommonDrift is 0.2 × 10\hat{ }(−3)
μs's Values are given in unit of corresponding granularity. This field is excluded when
determining changes in system information, i.e. changes of XXX should neither result in system
information change notifications nor in a modification of value Tag in SIB1.
taCommonDriftVariant
Indicate drift rate variation of the common TA. The granularity of TACommonDriftVariation
is 0.2 × 10\hat{ }(−4) μs/s\hat{ }2. Values are given in unit of corresponding granularity. This field is
excluded when determining changes in system information, i.e. changes of XXX should neither
result in system information change notifications nor in a modification of value Tag in SIB1.

### IoT NTN

The Non-Terrestrial Network described above is based on 5G/NR technology adapted for communication via satellites. An NTN standard for IoT, denoted as “IoT NTN”, is also being specified in release 17 of the 3GPP standards. IoT NTN is based on the LTE NB-IoT technology adapted for communication via satellites. To distinguish NTN based 5G/NR technology from IoT NTN, NTN based on 5G/NR technology is often referred to as “NR NTN”. In light of these distinctions, depending on the context, the term “NTN” is sometimes used to refer to either or both of NR NTN and IoT NTN, and sometimes the term “NTN” is used to refer only to NR NTN.

There currently exist certain challenge(s). As described above, there are two means for adjustment of the UE's timing advance (TA) in NTN (both NR NTN and IoT NTN): Using Timing Advance Command MAC CEs from the network (i.e. the legacy means) and using UE autonomous updates based on the UE's calculation of the propagation delay based on the UE's own location (typically acquired through GNSS measurements) and the broadcast ephemeris data and Common TA parameters associated with the serving cell and satellite. It is however unclear how these means interact.

An additional problem in IoT NTN is that an IoT NTN UE is not expected to be able to perform a GNSS measurement while receiving transmissions from network at the same time, which is problematic when the IoT NTN UE is supposed to perform a GNSS measurement to get fresh UE location information to be used in the TA calculation.

### SUMMARY

Certain aspects of the disclosure and their embodiments may provide solutions to these or other challenges. The proposed solution addresses the problems described above through the introduction of configuration means, principles, and methods in the network (e.g. in a gNB or an eNB) and in a UE.

In a first aspect of the disclosure, a method is performed by a UE in an NTN for determining a timing advance. The method comprises receiving, from a network node in the NTN, a first message comprising one or more instructions configuring the UE to perform positioning measurements. The positioning measurements indicate a location of the UE for use in determining the timing advance.

In a second aspect of the disclosure, a method is performed by a network node in an NTN for determining a timing advance. The method comprises transmitting, to a UE in the NTN, a first message comprising one or more instructions configuring the UE to perform positioning measurements. The positioning measurements indicate a location of the UE for use in determining the timing advance.

Embodiments of the disclosure may provide the network with means to control the tradeoff between the use of GNSS measurements (or other means for dynamically acquiring accurate position information) at the UE and sending of TA adjustment instructions (i.e. Timing Advance Command MAC CEs) from the network, when it comes to keeping the accuracy of the UE's timing advance (in terms of deviation from the optimal TA) within acceptable limits.

To this end, the network can instruct the UE to perform a GNSS measurement (or more generally to refresh its location information, using any available means), to perform GNSS measurements according to certain rule(s), or not to perform GNSS measurements, or to only perform GNSS measurements when certain condition(s) is/are fulfilled, or to perform GNSS measurements only on explicit instruction from the network. Any one of these instructions may correspond to the one or more instructions discussed in steps 302 and 402 of FIGS. 3 and 4, respectively.

This instruction message may be a MAC message, e.g. a modified Timing Advance Command MAC CE, e.g. used for ordering of a one-time GNSS measurement. Another alternative may be an RRC message, e.g. for configuration of rules or conditions for when the UE should perform GNSS measurements.

In some embodiments, the network may configure a GNSS measurement gap for an ordered GNSS measurement, or multiple measurement gaps when repetitive GNSS measurements are configured/ordered. The GNSS measurement gap(s) may correspond to the one or more periods of time discussed in steps 304 and 404 of FIGS. 3 and 4, respectively. Configuration of GNSS measurement gaps is particularly useful in the context of IoT NTN, since IoT NTN UEs are not expected to be able to perform GNSS measurements while simultaneously receiving and/or transmitting in the IoT NTN network.

Embodiments of the disclosure may provide the network with means to control the tradeoff between the use of GNSS measurements (or other means for dynamically acquiring accurate position information) at the UE and sending of TA adjustment instructions (i.e. Timing Advance Command MAC CEs) from the network, when it comes to keeping the accuracy of the UE's timing advance (in terms of deviation from the optimal TA) within acceptable limits.

This includes that the network can instruct the UE to perform a GNSS measurement (or more generally to refresh its location information, using any available means), to perform GNSS measurements according to certain rule(s), or not to perform GNSS measurements, or to only perform GNSS measurements when certain condition(s) is/are fulfilled, or to perform GNSS measurements only on explicit instruction from the network.

The network may also configure one or more GNSS measurement gaps matching one or more ordered GNSS measurements.

Certain embodiments may provide one or more of the following technical advantage(s). The proposed solution allows the two means for TA adjustment (i.e. Timing Advance Command MAC CEs and UE autonomous TA adaptations based on GNSS measurements and ephemeris and Common TA parameters) in NR NTN and IoT NTN to coexist and be used in a controlled manner. It also allows the network to control the extent to which TA adjustments are performed through UE autonomous adjustments and the extent to which they are handled via adjustment instructions from the network, i.e. Timing Advance Command MAC CEs. For IoT NTN, the proposed solution also provides a tailored means for the network to configure the UE with a GNSS measurement gap when a GNSS measurement may be needed for the UE autonomous TA adjustments.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a schematic diagram illustrating example architecture of a satellite network with bent pipe transponders;

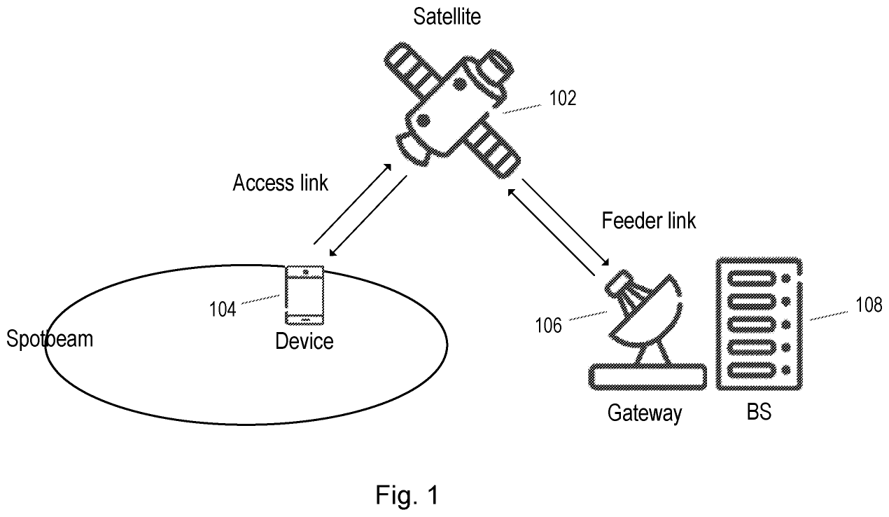

FIG. 2 is a schematic diagram illustrating parameters included in one ephemeris data format;

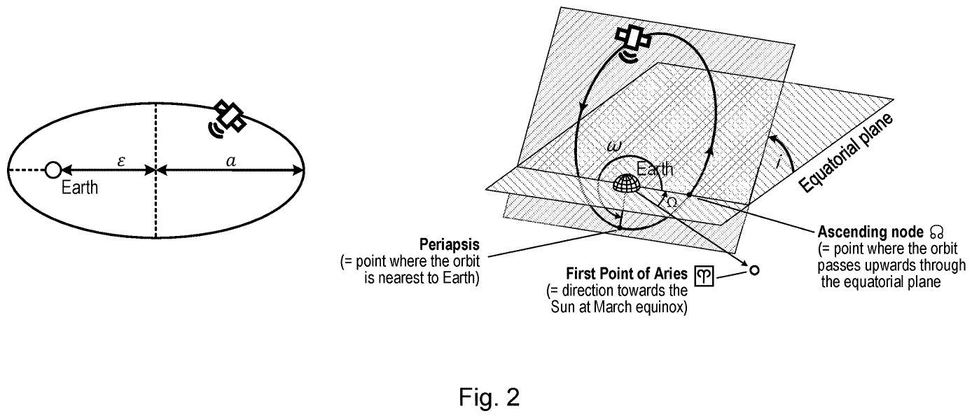

FIG. 3 is a schematic flowchart showing a method in accordance with some embodiments;

FIG. 4 is a schematic flowchart showing a method in accordance with some embodiments;

FIG. 5 shows an example of a communication system in accordance with some embodiments;

FIG. 6 shows a UE in accordance with some embodiments;

FIG. 7 shows a network node in accordance with some embodiments;

FIG. 8 is a block diagram of a host in accordance with various aspects described herein;

FIG. 9 is a block diagram illustrating a virtualization environment in which functions implemented by some embodiments may be virtualized; and

FIG. 10 is a block diagram showing a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

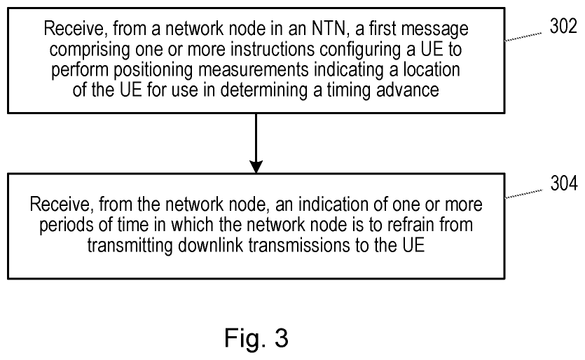

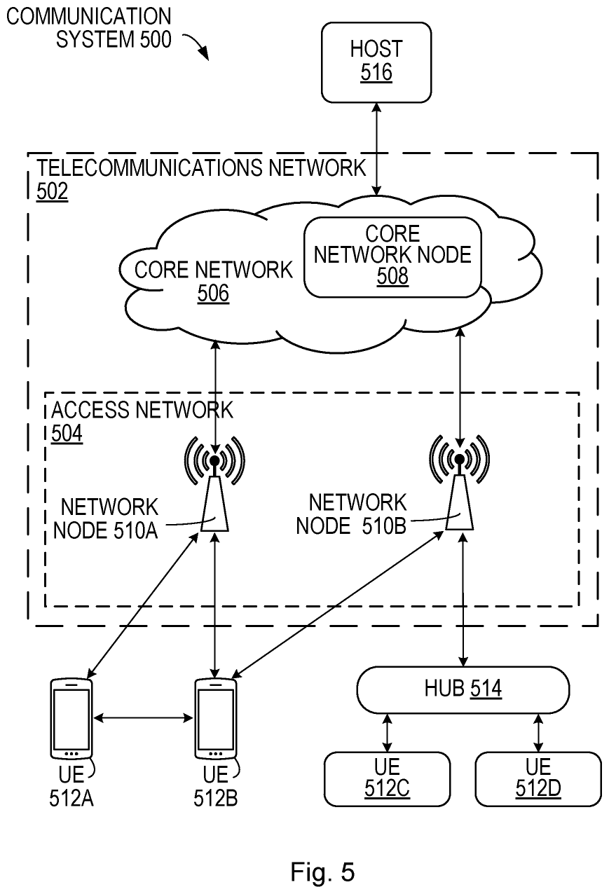

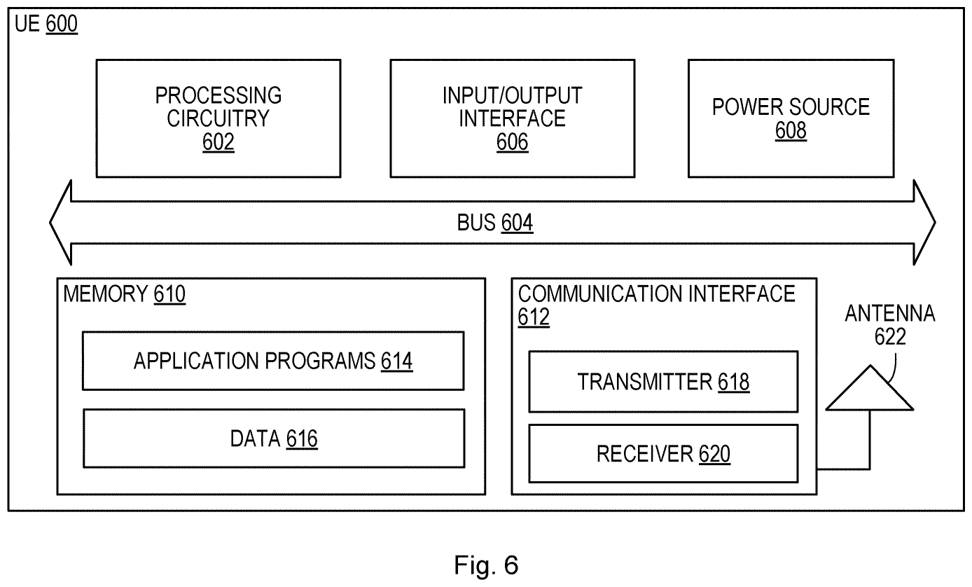

FIG. 3 depicts a method in accordance with particular embodiments. The method may be performed by a UE or wireless device (e.g. an NB-IoT device and/or the UE 512 or UE 600 as described later with reference to FIGS. 5 and 6 respectively) in an NTN (e.g., an IoT NTN or an NR NTN) for determining a timing advance.

The UE may be configured with one or more cells served by one or more NTN nodes. For example, the UE may be configured with a plurality of cells served by a single NTN node (e.g., using carrier aggregation). Alternatively or additionally, the UE may be configured with a plurality of cells served by more than one NTN node (e.g., using dual- or multi-connectivity). The different NTN nodes may use the same or different radio access technology. As used herein, an “NTN node” refers to a network node (e.g., a base station or other transmit-receive point) that is located on a non-terrestrial vehicle, such as a satellite. The NTN node may act as a relay (so-called “bent pipe” architecture) for communications between the UE and a terrestrial network node or base station. Alternatively, the NTN node may terminate communications between the UE, e.g., by demodulating and/or decoding transmissions signals received from the planetary surface (e.g., from the UE or another network node) and transmitting further communications to the planetary surface (e.g., to the UE or another network node). The NTN node may serve any of a Primary Cell (PCell), a Special Cell (sPCell), a Primary Secondary Cell (PSCell), etc.

The method begins at step 302 with the UE receiving, from a network node in the NTN, a first message (e.g., a first message comprising a MAC message or control element, an RRC message, a system information transmission, or downlink control information (DCI)). The first message comprises one or more instructions configuring the UE to perform positioning measurements indicating a location of the UE for use in determining the timing advance. For example, the positioning measurements may comprise GNSS measurements, trilateration measurements, and/or any type of measurements which may indicate a location of the UE. Accordingly, the UE may perform one or more actions (e.g., performing the measurements as indicated) in response to the one or more instructions.

The one or more instructions may correspond to one or more of the instructions discussed in section 2 below (specifically, in section 2.1 “Configuration related to GNSS measurements, GNSS validity time and TA adjustment instructions”).

In particular, the one or more instructions may comprise one or more of:
an instruction to perform one or more positioning measurements;
an instruction to perform periodic positioning measurements;
an instruction to refrain from performing positioning measurements; and
an instruction to perform one or more positioning measurements responsive to one or more conditions being fulfilled.

These one or more instructions may be based on information reported by the UE to the network node (e.g., information indicating a capability of the UE, an amount of power available at the UE, hardware of the UE, and a size of a timing advance reported to the network node by the UE, etc.).

In addition to the one or more instructions, the UE may receive, from the network node, a timing advance adjustment. For example, the timing advance adjustment may be received in a Timing Advance Command MAC CE.

In step 304 (which may be performed independently from step 302), the UE receives, from the network node, an indication of one or more periods of time in which the network node is to refrain from transmitting downlink transmissions to the UE. These one or more periods of time may correspond to the GNSS measurement gaps discussed in section 2 below (specifically in section 2.2, “Measurement gap configuration associated with GNSS measurement instructions”). The UE may perform one or more positioning measurements during at least one of the periods of time.

The positioning measurements may be associated with a validity time, upon expiry of which the positioning measurements are considered invalid. In view of this validity time, one or more of a start time and a periodicity of the periods of time in which the network node is to refrain from transmitting downlink transmissions to the UE may be based on the validity time (e.g., the periodicity of the periods of time corresponds to or is shorter than the validity time).

Furthermore, the one or more instructions may comprise an instruction to perform one or more positioning measurements based on an amount of time remaining of the validity time.

A validity timer corresponding to the validity time may be started upon the UE performing a positioning measurement. Additionally or alternatively, the validity timer corresponding to the validity time may be started upon reception of the first message by the user equipment, or upon transmission of the first message by the network node.

For the above method(s), the network node may be located on a non-terrestrial satellite and forwards data between a UE and a terrestrial-based network node. On the other hand, the network node may be terrestrial-based and receives data from a network node located on a non-terrestrial satellite forwarding data between a UE and the network node.

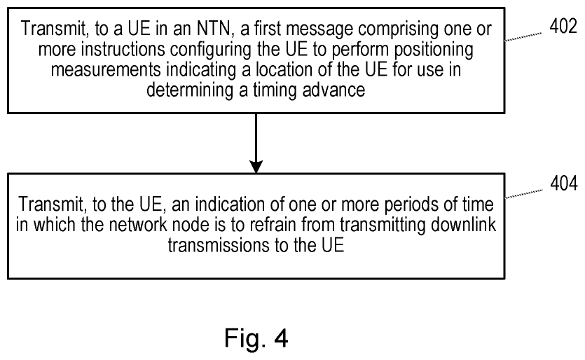

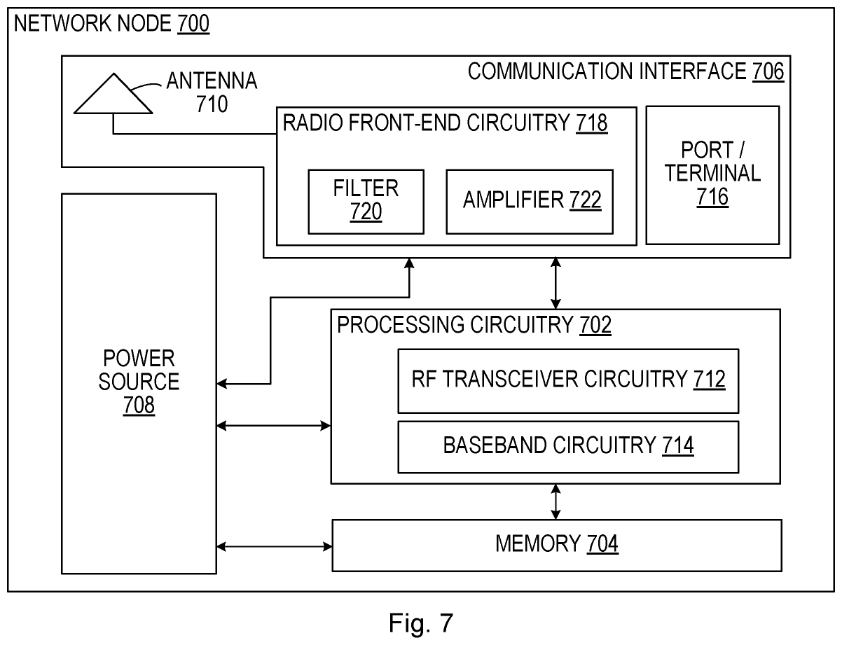

FIG. 4 depicts a method in accordance with particular embodiments. The method may be performed by a network node (e.g. the network node 510 or network node 700 as described later with reference to FIGS. 5 and 7 respectively) in an NTN (e.g. an IoT NTN or an NR NTN) for determining a timing advance. The method of FIG. 4 may be read in conjunction with the method of FIG. 3, which sets out a corresponding method performed by a UE.

The network node may be located on a non-terrestrial satellite and forward data between a UE and a terrestrial-based network node. Alternatively, the network node may be terrestrial-based and receives data from a network node located on a non-terrestrial satellite forwarding data between a UE and the network node.

The method begins at step 402 with the network node transmitting, to a user equipment (UE) (e.g., an NB-IoT device) in the NTN, a first message (e.g., a first message comprising a MAC message or control element, an RRC message, a system information transmission, and downlink control information (DCI)). The first message comprises one or more instructions configuring the UE to perform positioning measurements indicating a location of the UE for use in determining the timing advance. For example, the positioning measurements may comprise GNSS measurements, trilateration measurements, and/or any type of measurements which may indicate a location of the UE.

The one or more instructions may correspond to one or more of the instructions discussed in section 2 below (specifically, in section 2.1 “Configuration related to GNSS measurements, GNSS validity time and TA adjustment instructions”).

In particular, the one or more instructions may comprise one or more of:
an instruction to perform one or more positioning measurements;
an instruction to perform periodic positioning measurements;
an instruction to refrain from performing positioning measurements; and
an instruction to perform one or more positioning measurements responsive to one or more conditions being fulfilled.

These one or more instructions may be based on information reported by the UE to the network node (e.g., information indicating a capability of the UE, an amount of power available at the UE, hardware of the UE, and a size of a timing advance reported to the network node by the UE, etc.).

In addition to the one or more instructions, the network node may transmit, to the UE, a timing advance adjustment. For example, the timing advance adjustment may be transmitted in a Timing Advance Command MAC CE.

In step 404 (which may be performed independently from step 402), the network node transmits, to the UE, an indication of one or more periods of time in which the network node is to refrain from transmitting downlink transmissions to the UE. These one or more periods of time may correspond to the GNSS measurement gaps discussed in section 2 below (specifically in section 2.2, “Measurement gap configuration associated with GNSS measurement instructions”). The UE may perform one or more positioning measurements during at least one of the periods of time.

The positioning measurements may be associated with a validity time, upon expiry of which the positioning measurements are considered invalid. In view of this validity time, one or more of a start time and a periodicity of the periods of time in which the network node is to refrain from transmitting downlink transmissions to the UE may be based on the validity time (e.g., the periodicity of the periods of time corresponds to or is shorter than the validity time).

Furthermore, the one or more instructions may comprise an instruction to perform one or more positioning measurements based on an amount of time remaining of the validity time.

A validity timer corresponding to the validity time may be started upon the UE performing a positioning measurement. Additionally or alternatively, the validity timer corresponding to the validity time may be started upon reception of the first message by the user equipment, or upon transmission of the first message by the network node.

Sections 1 and 2 below discuss embodiments of the disclosure in further detail.

### 1. Notes

Note 1: In this solution description, the term Non-Terrestrial Network (NTN) may, depending on the context, refer to either or both of NR NTN and IoT NTN, and sometimes the term is used to refer to only NR NTN.

Note 2: The embodiments outlined below are described mainly in terms of NR based NTNs, but they are equally applicable in an NTN based on LTE technology (and in particular IoT NTN).

Note 3: The term “network” is used in the solution description to refer to a network node, which typically is a RAN node such as a gNB (e.g. in a NR based NTN) or an eNB (e.g. in an LTE based NTN, such as an IoT NTN), but which may also be a base station or an access point in another type of network, or any other network node with the ability to directly or indirectly communicate with a UE. Refinements with finer granularity are also conceivable. For instance, a gNB may be an en-gNB, and if a split gNB architecture is applied (dividing the gNB into multiple separate entities or notes), the term “node” may refer to a part of the gNB, such as a gNB-Central Unit (CU) (often referred to as just CU), a gNB-Distributed Unit (DU) (often referred to as just DU), a gNB-CU-Control Plane (CP) or a gNB-CU-User Plane (UP). Similarly, an eNB may be an ng-eNB, and if a split eNB architecture is applied (dividing the gNB into multiple separate entities or notes), the term “network” (and the network node it implies) may refer to a part of the eNB, such as an eNB-CU, an eNB-DU, an eNB-CU-CP or an eNB-CU-UP. Furthermore, the term “network” (and the network node it implies) may also refer to an Integrated Access and Backhaul (IAB)-donor, IAB-donor-CU, IAB-donor-DU, IAB-donor-CU-CP, or an IAB-donor-CU-UP.

Note 4: Ephemeris data is associated with (and applies to) a satellite. However, for convenience, ephemeris data may sometimes be described as associated with a cell, when the ephemeris data referred to actually is associated with the satellite serving the cell. This convenience practice may be seen e.g., in expressions like “a cell's ephemeris data” or “the ephemeris data of the cell”. Such expressions should be interpreted as short forms of more strictly correct expressions like “a cell's serving satellite's ephemeris data”, “the ephemeris data of the cell's serving satellite” or “the ephemeris data of the satellite serving the cell”.

Note 5: Herein it is sometimes referred to a validity time associated with ephemeris data and Common TA parameters. e.g., broadcast as system information. This refers to a validity time which is captured in an ASN.1 field denoted as “ntn-UlSyncValidityDuration-r17” or “ntn-UlSyncValidityDuration” in the RRC specification 3GPP TS 38.331 version 17.0.0.

Note 6: Herein it is sometimes referred to a validity time associated with ephemeris data and Common TA parameters. Other information may also be associated with this validity time, such as a Kmac parameter (and potentially all the parameters that may be included in an NTN-specific SIB, e.g. SIB19 in NR NTN or SIB31 in IoT NTN, but this other information is generally not assumed to be equally dynamic as the ephemeris data and Common TA parameters, and hence, for convenience, the validity time is herein referred to as being associated with ephemeris data and Common TA parameter, while other possible associated information is not mentioned.

Note 7: Although the embodiments are described for the case where the GNSS measurement gap is configured or ordered by the network, one or more of the embodiments are also applicable to the case where the GNSS measurement gap and/or a certain configuration of the measurement gap is requested by the UE.

Note 8: The term “GNSS almanac” refers to any additional information about a GNSS system such as the coarse orbit or status information of every satellite in the constellation, the relevant ionospheric model and time-related information that help a GNSS receiver to acquire satellite signals from a cold or warm start. An ephemeris message is still required from each satellite for the receiver to compute the exact position, but it is the almanac for the constellation that gives the receiver its starting point and assists in accelerating the whole process.

Note 9: The term “satellite” is sometimes used in the solutions, but the solutions apply also to High-Altitude Platform Station (HAPS) on any NTN payload type, thus “satellite” is sometimes used with the meaning “satellite or HAPS or any NTN payload”.

Note 10: A position determined based on a GNSS measurement, or the act of determining a position based on a GNSS measurement, is also referred to as a “position fix”.

Note 11: A position determined based on a GNSS measurement is sometimes referred to as a “GNSS position”.

Note 12: The terms “position” and “location” are used interchangeably herein.

### 2. Solution

In some respects, the embodiments discussed in this section may correspond to the methods shown in FIGS. 3 and 4.

The proposed solution addresses the problems described above through the introduction of configuration means, principles, and methods in the network (e.g. in a gNB or an eNB) and in a UE.

The essence of the solution is to provide the network with means to control the tradeoff between the use of GNSS measurements (or other means for dynamically acquiring accurate position information) at the UE and sending of TA adjustment instructions (i.e. Timing Advance Command MAC CEs) from the network, when it comes to keeping the accuracy of the UE's timing advance (in terms of deviation from the optimal TA) within acceptable limits.

### 2.1 Configuration Related to GNSS Measurements, GNSS Validity Time and TA Adjustment Instructions

For the purpose of controlling the above mentioned tradeoff between GNSS measurements and TA adjustment instructions (e.g. Timing Advance Command MAC CEs) from the network, in some embodiments, the network can instruct the UE to perform a GNSS measurement (or more generally to refresh its location information, using any available means), to perform GNSS measurements according to certain rule(s), or not to perform GNSS measurements, or to only perform GNSS measurements when certain condition(s) is/are fulfilled, or to perform GNSS measurements only on explicit instruction from the network. This may be done, for example, using the method discussed in relation to FIGS. 3 and 4. The GNSS measurement(s) (or more generally the measurement(s) to refresh the UE's location information, using any available means) may correspond to the positioning measurements of steps 302 and 402.

This instruction may be sent (e.g., via step 402) from the network (e.g. a gNB in NR NTN or an eNB in IoT NTN) in a message (e.g., the first message of steps 302 and 402). This message may be a MAC message, e.g. a modified Timing Advance Command MAC CE, e.g. used for ordering of a one-time GNSS measurement. Another example may be an RRC message, e.g. for configuration of rules or conditions for when the UE should perform GNSS measurements. The RRC message may be a dedicated message, addressed to a specific UE, or it may be a System Information (SI) message carrying a SIB containing the instruction in the form of configuration data. The SIB could e.g. be SIB19 in NR NTN and/or SIB31 in IoT NTN. Yet another alternative could be a DCI sent on the PDCCH, addressed to a specific UE, or possibly to a group of UEs (e.g. using a Group Common PDCCH (GC-PDCCH)).

In some embodiments, the network can instruct the UE to perform a (potentially one-time) GNSS measurement (e.g., using one of the one or more instructions of step 302 and 402). The network, e.g. gNB or an eNB, could do this e.g. using a MAC CE, e.g. the Timing Advance Command MAC CE, e.g. using a flag or by indicating a dedicated TA adjustment value, such as infinity or maybe zero (if zero is not already accepted as a “dummy” adjustment instruction). The instruction may also be sent as DCI on the PDCCH, making it a sort of PDCCH ordered position measurement. Extended variants of the instruction could have the meaning “perform a GNSS measurement and report the accurate result”, “perform a GNSS measurement and report the coarse result” or “perform a GNSS measurement and report the TA calculated based on it”.

Together with such a GNSS measurement (or other UE location measurement) instruction, as another option, the network may control the UE's GNSS validity timer (for example, the validity timer discussed in relation to FIGS. 3 and 4), e.g. disabling it or instructing/configuring/triggering when to restart it. As one such option, the instruction to the UE to perform a GNSS measurement may also mark the start time of the GNSS validity timer for the GNSS measurement the UE may perform. More accurate from the UE's point of view would be to start this timer when the GNSS measurement has actually been performed, but since the network does not know exactly when this happens, starting the GNSS validity timer at a point in time defined in relation to when the instruction is sent/received (e.g. exactly at the end of the (last) slot in which the instruction was received (for CE repetitions, the last repetition may be used as such a reference)) allows the UE and the network to be synchronized with regards to the GNSS validity timer without the UE having to report the time remaining for the validity timer. If a measurement gap (e.g., one of the one or more periods of time of steps 304 and 404) is configured for the GNSS measurement (discussed in detail below), the validity timer could alternatively be (re) started at the beginning or at the end of the GNSS measurement gap.

If the UE can also perform GNSS measurements on its own decision, i.e. without being triggered by the network or following an instruction from the network, the network's perception of the UE's remaining GNSS validity time may be incorrect, unless the UE reports the remaining GNSS validity time after each GNSS measurement. To avoid mismatch between the UE and the network and the remaining GNSS validity time, as well as to avoid excessive signaling to maintain this synchronization between the UE and the network, the network could have the possibility to configure the UE to “perform GNSS measurements only upon instruction from the network”. This could be configuration sent to an individual UE through dedicated signaling, e.g. using an RRC message or a MAC message (e.g. a MAC CE). As another option, the configuration could apply to all UEs in the cell, e.g. conveyed via the system information.

An alternative could be a configuration meaning “perform GNSS measurement upon instruction from the network or when only a time duration T (e.g. measured in seconds or milliseconds), or (as another option) X %, remains of the GNSS validity time” (e.g., sent as one of the one or more instructions of steps 302 and 402). To maintain UE-network synchronization on the perception of the validity time with this option, it may be implicit that the validity time should be restarted (retroactively after the GNSS measurement has been performed) from the point in time when a duration T, or (as another option) X % remained of the previous validity time. If the UE fails to perform the GNSS measurement, it should, if possible (e.g. if the validity time of the previous GNSS measurement, and thus the UE's UL synchronization, has not yet fully expired), report this to the network and the network can then, if preferred, keep the UE from losing UL synchronization by sending a Timing Advance Command MAC CE (possibly followed by subsequent Timing Advance Command MAC CEs, e.g. if the UE keeps failing to perform GNSS measurements, e.g. because of poor GNSS signal coverage). Additionally, the network may also send a Frequency Adjustment command using a new MAC CE (exclusively for frequency adjustment or which may contain both timing and/or frequency adjustment commands).

A variation of the above instruction could be an instruction from the network (e.g., one of the one or more instructions of steps 302 and 402) to the UE to “never perform an unsolicited GNSS measurement unless less than a duration T, or less than X %, remains of the GNSS validity time”.

As one extreme of the range of the tradeoff between GNSS measurements and TA adjustment instructions (e.g. Timing Advance Command MAC Ces) from the network, the network can inform the UE that the UE is solely responsible for maintaining a valid TA and that the network is not going to send any TA adjustment instructions (e.g. Timing Advance Command MAC Ces) (e.g., via the one or more instructions of steps 302 and 402). As the other extreme of the range of the tradeoff between GNSS measurements and TA adjustment instructions (e.g. Timing Advance Command MAC CEs) from the network, the network may configure the UE to fully rely on the network to maintain a valid TA in the UE through TA adjustment instructions (e.g. Timing Advance Command MAC CEs) while the UE is in RRC_CONNECTED state (and consequently the UE does not have to perform any GNSS measurements for the purpose of calculating a TA while in RRC_CONNECTED state) (e.g., via the one or more instructions of steps 302 and 402). Optionally, this configuration may also apply to frequency adjustments, e.g. for Doppler shift compensation. Optionally, the time alignment timer may be not used (e.g. deactivated, deconfigured, or set to the value ‘infinity’ or simply unused or non-existent by specification) together with this configuration alternative. However, if the time alignment timer is used, and it expires, the UE may have to perform a GNSS measurement to calculate its TA (and possibly its frequency adjustment, e.g. Doppler shift compensation), or perform a random access procedure to reacquire UL synchronization, or both, i.e. first perform a GNSS measurement to calculate a TA (and possibly frequency adjustment, e.g. Doppler shift compensation) which is used for the random access preamble transmission and then receive a refined TA adjustment instruction (and possibly a refined frequency adjustment instruction) in the Random Access Response message (or MsgB if 2-step random access is used).

Using the means described above (e.g., the methods shown in relation to FIGS. 3 and 4), the network can choose an “operating point” for the tradeoff between GNSS measurements and TA adjustment instructions (e.g. Timing Advance Command MAC CEs) from the network. As an option, the network could use UE capability information (e.g. about whether the UE can perform GNSS measurements without measurements gaps and possibly a class or category indicating how much of an effort a GNSS measurement can be regarded to be, e.g. explicitly or implicitly indicating how frequently the UE can “sustainably” perform GNSS measurements) and/or dynamic status information (e.g. about the UE's energy source, e.g., the current status (such as power cable, charger, battery, solar cell, energy harvesting . . . ) and current energy status (e.g. battery level, remaining uptime, . . . )) as input to a determination of an “operating point” for a tradeoff between usage of Timing Advance Command MAC CEs from the network and GNSS measurements performed by the UE. Moreover, the similar methods can be used to choose an operating point while considering the tradeoff between GNSS measurements and TA/frequency adjustment instructions when the network also sends a frequency adjustment commands e.g., using a new MAC CE (exclusively for frequency adjustment or which may contain both timing and/or frequency adjustment commands).

If the network has instructed the UE to only perform GNSS measurements on instruction from the network, or only perform GNSS measurements according to a certain rule or when a certain condition is fulfilled, the UE can save energy by refraining from GNSS measurements except as instructed by the network. However, even while refraining from GNSS measurements, the UE can perform other useful actions, e.g. between the GNSS measurements, e.g. one of the following:
Keep track of its movements based on sensors, such as accelerometers, gyroscopes, compasses, barometers, etc.
Assume that it is stationary.
Measure velocity in conjunction with the GNSS measurement(s) and then assume unchanged velocity (or changed velocity as indicated by accelerometers and/or a gyroscope).

As another option, the UE could extend/prolong the remainder of its GNSS validity time, or even restart the GNSS validity timer, every time the UE receives a TA adjustment instruction (e.g. a Timing Advance Command MAC CE) from the network. Whether to restart or extend the GNSS validity timer (or leave it unaffected), and how much to extend it, may be configurable, in the Timing Advance Command MAC CE, in the system information, in a dedicated RRC message (such as an RRCReconfiguration message) or it may be specified. Similarly, if the network additionally sends frequency adjustment instructions to the UE, the UE can account for both the timing and frequency when extending or updating the GNSS validity timer.

As another option, the network could let the size of a (from the UE) reported TA be (part of) the basis for when to instruct the UE to refresh its position measurement (e.g. perform a new GNSS measurement). For instance, if the size is getting close to the cell specific/common K_{offset}, this may trigger the network to instruct the UE to refresh its position measurement (e.g. perform a new GNSS measurement) and possibly also to refresh its stored ephemeris and Common TA parameters

### 2.2 Measurement Gap Configuration Associated with GNSS Measurement Instructions

In general, to facilitate a UE to perform GNSS measurements, the network may configure GNSS measurement gaps (e.g., via step 404) during which the UE may perform GNSS measurements without having to monitor any DL transmissions in the NTN. This is particularly useful in IoT NTN since IoT NTN UEs (according to the standard specifications) are not expected to be able to perform GNSS measurements while simultaneously receiving and/or transmitting in the IoT NTN network.

Therefore, in some embodiments, the network may configure a GNSS measurement gap for an ordered GNSS measurement, or multiple measurement gaps when repetitive GNSS measurements are configured/ordered (e.g. periodic GNSS measurement gaps matching configured/ordered periodic GNSS measurements). The GNSS measurement gap(s) may correspond to the one or more periods of time indicated in steps 304 and 404.

The instruction to perform a GNSS measurement (or at least refresh the position measurement) may be accompanied by an allocation of a GNSS measurement gap to be used for the GNSS measurement. Optionally, this is only enabled for IoT NTN. When the instruction configures the UE to perform GNSS measurements according to a rule that allows the network (e.g. an eNB in IoT NTN) to predict when the UE is going to perform the GNSS measurements (such as when the rule is that the GNSS measurements should be performed periodically, e.g. with a periodicity matching the GNSS validity time the UE uses (or slightly shorter)), the instruction may simultaneously (or optionally in a separate instruction/message) configure GNSS measurement gaps for the UE, where the GNSS measurement gaps match (i.e. are synchronized with) the configured GNSS measurements. When the periodicity is configured to match the GNSS validity time the UE uses (which the UE may have reported to the network), e.g. slightly shorter than the UE's GNSS validity time to provide some margin, this may be seen such that the configuration of the periodic GNSS measurements and the matching periodic GNSS measurement gaps is done in relation to the UE's GNSS validity time, and the network may leverage this property in the configuration, e.g. by referring to the UE's current running GNSS validity timer when configuring the offset to the first of the multiple GNSS measurements and GNSS measurement gaps.

### 2.3 Additional Embodiments

The following embodiment (which may be seen as an extension of the methods shown in FIGS. 3 and 4) provides additional scheduling flexibility to the network while keeping the UE from making excessive GNSS position fixes, or unnecessarily leaving the connected mode to perform GNSS measurement. In this embodiment, when the network cannot configure, or chooses not to configure, a GNSS measurement gap in synchronization with the UE's remaining GNSS validity time (i.e., before the GNSS validity timer expires), but can configure it after the GNSS validity timer expiry, the network may allow the UE to consider its GNSS position to be valid for an additional duration. This can be achieved in one or more of the following ways:
The network sends timing advance adjustment instruction(s) and/or frequency adjustment instruction(s) and this implicitly indicates that the UE may consider its GNSS position to be valid for an additional duration. The duration may be explicitly signaled, configured via RRC signaling, configured in the system information (e.g. in terms of a time alignment timer and/or a frequency adjustment timer) or it may be hardcoded in a standard specification.
The network sends timing advance adjustment instruction(s) and/or frequency adjustment instruction(s) with an explicit indication that the UE may consider its GNSS position to be valid for an additional duration. The duration may be explicitly signaled, configured via RRC signaling, configured in the system information (e.g. in terms of a time alignment timer and/or a frequency adjustment timer) or it may be hardcoded in a standard specification.
The network explicitly extends the UE's GNSS validity timer or resets it. The network may extend the UE's GNSS validity timer with a duration equal to or longer than the gap between the instant when the UE's GNSS validity timer would expire without the extension or reset until the instant the next configured GNSS measurement gap is to occur. If the option by which the network resets the UE's GNSS validity timer is used, the reset timer should be started at a value large enough for the timer not to expire before the configured GNSS measurement gap. If the UE's GNSS validity timer is reset and restarted at a smaller value, the network may subsequently signal extension or reset/restart of the timer in order to fill the time gap until the configured GNSS measurement gap occurs.
The network does not extend or change the UE's GNSS validity timer, but a new “time gap” is defined during which the UE may continue to perform some or all of the functions that it is allowed to perform while a GNSS validity timer is running.
The UE behavior in this context may be specified such that the GNSS position is deemed valid for a certain duration even after the UE's GNSS validity timer expires, if one or more conditions are fulfilled, e.g.,
   the network-configured GNSS measurement gap is expected to occur within a certain prespecified or configured time duration following the GNSS validity timer expiry;
   the UE cannot perform GNSS measurement in RRC_CONNECTED state;
   the GNSS measurement gap is network-ordered;
   the GNSS measurement gap is requested by the UE.
The network instructs the UE not to perform GNSS measurement until the occurrence of the next GNSS measurement gap.

In some embodiments, the network may configure a GNSS measurement gap (e.g., one period of time in step 404) for a network-ordered GNSS measurement, or multiple measurement gaps (e.g., more than one period of time in step 404) when repetitive GNSS measurements are configured/ordered (e.g., periodic GNSS measurement gaps matching configured/ordered periodic GNSS measurements) based on feedback/information from the UE regarding whether the GNSS receiver is in cold, warm or hot state. Such information can be provided in response to the GNSS measurement order, e.g., via a MAC message (e.g. a MAC CE) or an RRC message, before the measurement gap is configured or based on separate feedback from the UE as part of UE assistance information, e.g. to inform the network every time the state of the GNSS receiver is updated, e.g., changes between cold, warm and hot state (so that the network can estimate what GNSS measurement time to assume and thus can configure the GNSS measurement gap(s) accordingly).

In another embodiment, along with a GNSS measurement instruction or configuration rule (as the one or more instructions of steps 302 and 402), the network may provide GNSS almanac information (and possibly satellite ephemeris data), for instance via an RRC message, so as to speed up the GNSS position acquisition process, configure shorter GNSS measurement gaps and, thus, limit the service interruption and energy consumption (e.g. battery drainage). The usability of the GNSS highly depends on the knowledge of which satellites may be visible from the UE location at a certain time. Therefore, the network (e.g., eNB or gNB) can request the GNSS almanac (and possibly satellite ephemeris data) that best applies to the UE from the Operation and Maintenance (O&M) system or the NTN Configuration Center (NCC) by providing specific information that allows to identify the UE's location (or the UE's serving cell as a rough location indication). This specific information is deployment specific, and/or location specific, and might include, but is not limited to, a cell ID and/or a satellite ID. In a variant, the network may request or leverage the feedback/information about the UE's GNSS receiver state described in the previous embodiment and only send the almanac (and possibly satellite ephemeris data) to those UEs that report a cold state. As an option in this variant, the network may also send the almanac (and possibly satellite ephemeris data), or a subset thereof, to a UE whose GNSS receiver is in warm state.

FIG. 5 shows an example of a communication system 500 in accordance with some embodiments.

In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3^{rd} Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections. In embodiments of the disclosure, the network nodes 510 may be NTN nodes, or terrestrial nodes that are connected to NTN nodes. As used herein, an “NTN node” refers to a network node (e.g., a base station or other transmit-receive point) that is located on a non-terrestrial vehicle, such as a satellite. The NTN node may act as a relay (so-called “bent pipe” architecture) for communications between the UE and a terrestrial network node or base station. Alternatively, the NTN node may terminate communications between the UE, e.g., by demodulating and/or decoding transmissions signals received from the planetary surface (e.g., from the UE or another network node) and transmitting further communications to the planetary surface (e.g., to the UE or another network node). The first NTN node may be any of a PCell, an sPCell, an PSCell, etc.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 5, the hub 514 communicates with the access network 504 to facilitate indirect communication between one or more UEs (e.g., UE 512c and/or 512d) and network nodes (e.g., network node 510b). In some examples, the hub 514 may be a controller, router, a content source and analytics node, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

FIG. 6 shows a UE 600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs). The processing circuitry 602 may be operable to provide, either alone or in conjunction with other UE 600 components, such as the memory 610, UE 600 functionality. For example, the processing circuitry 602 may be configured to cause the UE 602 to perform the methods as described with reference to FIG. 3.

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In some embodiments, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 600 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 7 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes processing circuitry 702, a memory 704, a communication interface 706, and a power source 708, and/or any other component, or any combination thereof. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, network node 700 functionality. For example, the processing circuitry 702 may be configured to cause the network node to perform the methods as described with reference to FIG. 4.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

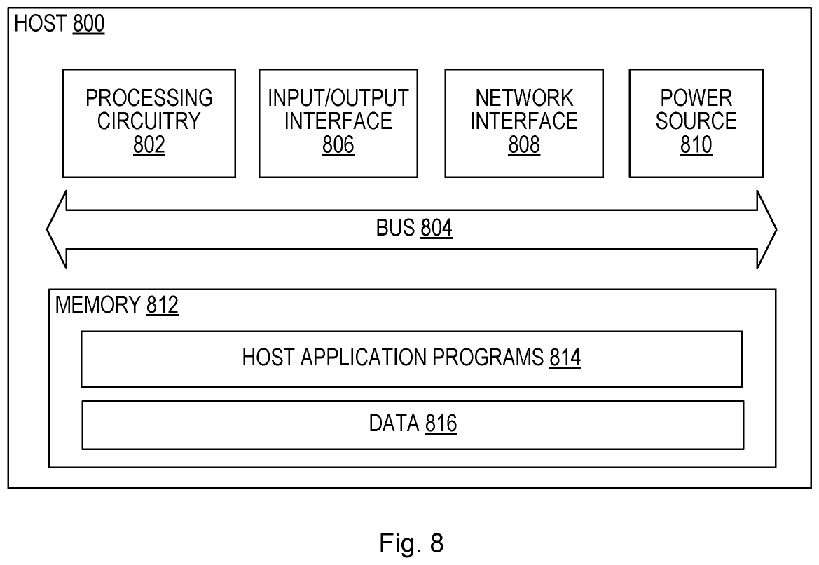

FIG. 8 is a block diagram of a host 800, which may be an embodiment of the host 516 of FIG. 5, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

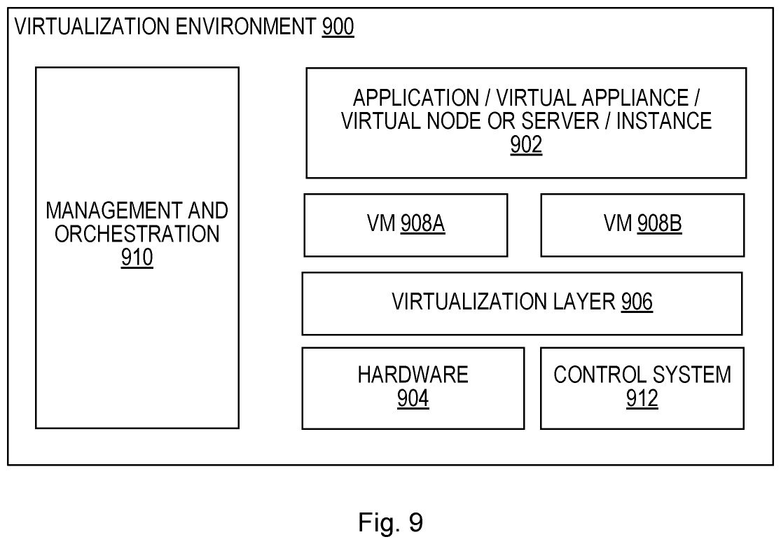

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

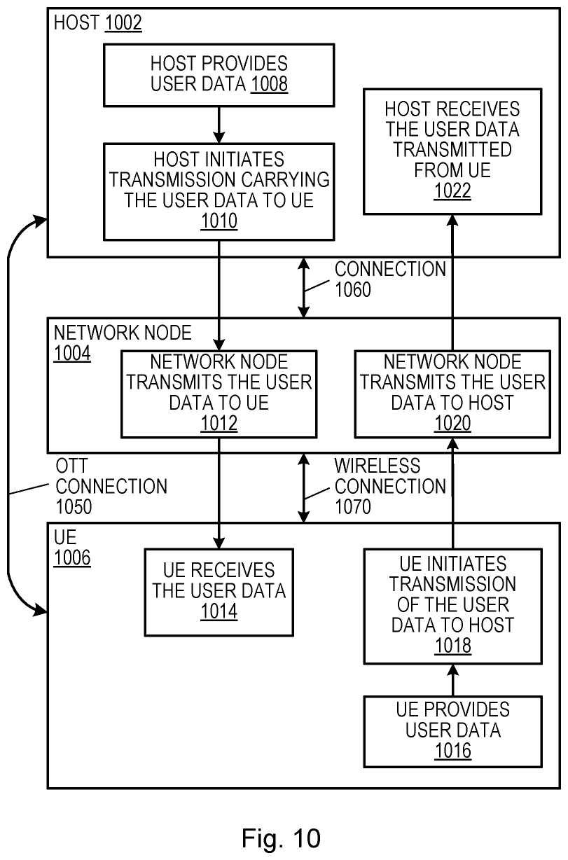

FIG. 10 shows a communication diagram of a host 1002 communicating via a network node 1004 with a UE 1006 over a partially wireless connection in accordance with some embodiments. Example implementations, in accordance with various embodiments, of the UE (such as a UE 512a of FIG. 5 and/or UE 600 of FIG. 6), network node (such as network node 510a of FIG. 5 and/or network node 700 of FIG. 7), and host (such as host 516 of FIG. 5 and/or host 800 of FIG. 8) discussed in the preceding paragraphs will now be described with reference to FIG. 10.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 5) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve the latency and power consumption of a UE and thereby provide benefits such as reduced user waiting time, better responsiveness, and/or extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

For the avoidance of doubt, the following numbered statements set out embodiments of the disclosure:

### Group A Embodiments

1. A method performed by a user equipment, UE, in a non-terrestrial network, NTN, for determining a timing advance, the method comprising:
   receiving, from a network node in the NTN, a first message comprising one or more instructions configuring the UE to perform positioning measurements indicating a location of the UE for use in determining the timing advance.
2. The method according to embodiment 1, wherein the one or more instructions comprise one or more of:
   an instruction to perform one or more positioning measurements;
   an instruction to perform periodic positioning measurements;
   an instruction to refrain from performing positioning measurements; and
   an instruction to perform one or more positioning measurements responsive to one or more conditions being fulfilled.
3. The method according to any one of the preceding embodiments, wherein the first message comprises one of:
   a MAC message or control element;
   an RRC message;
   a system information transmission; and
   downlink control information, DCI.
4. The method according to any one of the preceding embodiments, the method further comprising:
   receiving, from the network node, a timing advance adjustment.
5. The method according to embodiment 4, wherein the timing advance adjustment is received in a Timing Advance Command MAC CE.
6. The method according to any one of the preceding embodiments, the method further comprising:
   receiving, from the network node, an indication of one or more periods of time in which the network node is to refrain from transmitting downlink transmissions to the UE.
7. The method according to embodiment 6, the method further comprising performing one or more positioning measurements during at least one of the periods of time.
8. The method according to any one of the preceding embodiments, wherein the positioning measurements are associated with a validity time, upon expiry of which the positioning measurements are considered invalid.
9. The method according to embodiment 8, wherein a validity timer corresponding to the validity time is started upon performing a positioning measurement.
10. The method according to embodiment 8, wherein a validity timer corresponding to the validity time is started upon reception of the first message by the user equipment, or upon transmission of the first message by the network node.
11. The method according to any one of embodiments 8 to 10, wherein the one or more instructions comprise an instruction to perform one or more positioning measurements based on an amount of time remaining of the validity time.
12. The method according to any one of embodiments 8 to 10, when dependent on embodiments 6 or 7, wherein one or more of a start time and a periodicity of the periods of time in which the network node is to refrain from transmitting downlink transmissions to the UE are based on the validity time.
13. The method according to embodiment 12, wherein the periodicity of the periods of time corresponds to or is shorter than the validity time.
14. The method according to any one of the preceding embodiments, wherein the one or more instructions are based on information reported by the UE to the network node.
15. The method according to embodiment 14, wherein the information reported by the UE indicates one or more of:
   a capability of the UE;
   an amount of power available at the UE;
   hardware of the UE; and
   a size of a timing advance reported to the network node by the UE.
16. The method according to any one of the preceding embodiments, wherein the positioning measurements comprise one or more of:
   GNSS measurements; and
   trilateration measurements.
17. The method according to any one of the preceding embodiments, wherein:
   the user equipment is an NB-IoT device.
18. The method according to any one of the preceding embodiments, wherein:
   the NTN is an IoT NTN or an NR NTN.
19. The method according to any one of the preceding embodiments, wherein:
   the network node is located on a non-terrestrial satellite and forwards data between the UE and a terrestrial-based network node; or
   the network node is terrestrial-based and receives data from a network node located on a non-terrestrial satellite forwarding data between the UE and the network node.
20. The method according to any of the previous embodiments, further comprising:
   providing user data; and
   forwarding the user data to a host via the transmission to the network node.

### Group B Embodiments

21. A method performed by a network node in a non-terrestrial network, NTN, for determining a timing advance, the method comprising:
   transmitting, to a user equipment, UE, in the NTN, a first message comprising one or more instructions configuring the UE to perform positioning measurements indicating a location of the UE for use in determining the timing advance.
22. The method according to embodiment 21, wherein the one or more instructions comprise one or more of:
   an instruction to perform one or more positioning measurements;
   an instruction to perform periodic positioning measurements;
   an instruction to refrain from performing positioning measurements; and
   an instruction to perform one or more positioning measurements responsive to one or more conditions being fulfilled.
23. The method according to any one of embodiments 21 to 22, wherein the first message comprises one of:
   a MAC message or control element;
   an RRC message;
   a system information transmission; and
   downlink control information, DCI.
24. The method according to any one of embodiments 21 to 23, the method further comprising:
   transmitting, to the UE, a timing advance adjustment.
25. The method according to embodiment 24, wherein the timing advance adjustment is transmitted in a Timing Advance Command MAC CE.
26. The method according to any one of embodiments 21 to 25, the method further comprising:
   transmitting, to the UE, an indication of one or more periods of time in which the network node is to refrain from transmitting downlink transmissions to the UE.
27. The method according to embodiment 26, wherein the one or more periods are for the UE to performs one or more positioning measurements.
28. The method according to any one of embodiments 21 to 27, wherein the positioning measurements are associated with a validity time, upon expiry of which the positioning measurements are considered invalid.
29. The method according to embodiment 28, wherein a validity timer corresponding to the validity time is started upon performing a positioning measurement.
30. The method according to embodiment 28, wherein a validity timer corresponding to the validity time is started upon reception of the first message by the user equipment, or upon transmission of the first message by the network node.
31. The method according to any one of embodiments 28 to 30, wherein the one or more instructions comprise an instruction to perform one or more positioning measurements based on an amount of time remaining of the validity time.
32. The method according to any one of embodiments 28 to 30, when dependent on embodiments 26 or 27, wherein one or more of a start time and a periodicity of the periods of time in which the network node is to refrain from transmitting downlink transmissions to the UE are based on the validity time.
33. The method according to embodiment 32, wherein the periodicity of the periods of time corresponds to or is shorter than the validity time.
34. The method according to any one of embodiments 21 to 33, wherein the one or more instructions are based on information reported by the UE to the network node.
35. The method according to embodiment 34, wherein the information reported by the UE indicates one or more of:
   a capability of the UE;
   an amount of power available at the UE;
hardware of the UE; and
   a size of a timing advance reported to the network node by the UE.
36. The method according to any one of embodiments 21 to 35, wherein the positioning measurements comprise one or more of:
   GNSS measurements; and
   trilateration measurements.
37. The method according to any one of embodiments 21 to 36, wherein:
   the user equipment is an NB-IoT device.
38. The method according to any one of embodiments 21 to 37, wherein:
   the NTN is an IoT NTN or an NR NTN.
39. The method according to any one of embodiments 21 to 38, wherein:
   the network node is located on a non-terrestrial satellite and forwards data between the UE and a terrestrial-based network node; or
   the network node is terrestrial-based and receives data from a network node located on a non-terrestrial satellite forwarding data between the UE and the network node.
40. The method according to any of the previous embodiments, further comprising:
   obtaining user data; and
   forwarding the user data to a host or a user equipment.

### Group C Embodiments

41. A user equipment, UE, in a non-terrestrial network, NTN, for determining a timing advance, comprising:
   processing circuitry configured to cause the user equipment to perform any of the steps of any of the Group A embodiments; and
   power supply circuitry configured to supply power to the processing circuitry.
42. A network node in a non-terrestrial network, NTN, for determining a timing advance, the network node comprising:
   processing circuitry configured to cause the network node to perform any of the steps of any of the Group B embodiments;
   power supply circuitry configured to supply power to the processing circuitry.
43. A user equipment, UE, in a non-terrestrial network, NTN, for determining a timing advance, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
44. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
45. The host of the previous embodiment, wherein the cellular network further includes a network node configured to communicate with the UE to transmit the user data to the UE from the host.
46. The host of the previous 2 embodiments, wherein:
   the processing circuitry of the host is configured to execute a host application, thereby providing the user data; and
   the host application is configured to interact with a client application executing on the UE, the client application being associated with the host application.
47. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
48. The method of the previous embodiment, further comprising:
   at the host, executing a host application associated with a client application executing on the UE to receive the user data from the UE.
49. The method of the previous embodiment, further comprising:
   at the host, transmitting input data to the client application executing on the UE, the input data being provided by executing the host application,
   wherein the user data is provided by the client application in response to the input data from the host application.
50. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
51. The host of the previous embodiment, wherein the cellular network further includes a network node configured to communicate with the UE to transmit the user data from the UE to the host.
52. The host of the previous 2 embodiments, wherein:
   the processing circuitry of the host is configured to execute a host application, thereby providing the user data; and
   the host application is configured to interact with a client application executing on the UE, the client application being associated with the host application.
53. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
54. The method of the previous embodiment, further comprising:
   at the host, executing a host application associated with a client application executing on the UE to receive the user data from the UE.
55. The method of the previous embodiment, further comprising:
   at the host, transmitting input data to the client application executing on the UE, the input data being provided by executing the host application,
   wherein the user data is provided by the client application in response to the input data from the host application.
56. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
57. The host of the previous embodiment, wherein:
   the processing circuitry of the host is configured to execute a host application that provides the user data; and
   the UE comprises processing circuitry configured to execute a client application associated with the host application to receive the transmission of user data from the host.
58. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
59. The method of the previous embodiment, further comprising, at the network node, transmitting the user data provided by the host for the UE.
60. The method of any of the previous 2 embodiments, wherein the user data is provided at the host by executing a host application that interacts with a client application executing on the UE, the client application being associated with the host application.
61. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
62. The communication system of the previous embodiment, further comprising:
   the network node; and/or
   the user equipment.
63. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
64. The host of the previous embodiment, wherein:
   the processing circuitry of the host is configured to execute a host application, thereby providing the user data; and
   the host application is configured to interact with a client application executing on the UE, the client application being associated with the host application.
65. The host of the any of the previous 2 embodiments, wherein the initiating receipt of the user data comprises requesting the user data.
66. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
67. The method of the previous embodiment, further comprising at the network node, transmitting the received user data to the host.

1-38. (canceled)

39. A method performed by a user equipment (UE) in a non-terrestrial network (NTN) for determining a timing advance, the method comprising:
receiving, from a network node in the NTN, a first message comprising one or more instructions configuring the UE to perform positioning measurements, wherein the positioning measurements indicate a location of the UE for use in determining the timing advance.

40. The method according to claim 39, wherein the one or more instructions comprise one or more of:
an instruction to perform one or more positioning measurements;
an instruction to perform periodic positioning measurements;
an instruction to refrain from performing positioning measurements; and
an instruction to perform one or more positioning measurements responsive to one or more conditions being fulfilled.

41. The method according to claim 39, the method further comprising receiving, from the network node, a timing advance adjustment.

42. The method according to claim 39, the method further comprising receiving, from the network node, an indication of one or more periods of time in which the network node is to refrain from transmitting downlink transmissions to the UE.

43. The method according to claim 42, the method further comprising performing one or more positioning measurements during at least one of the periods of time.

44. The method according to claim 39, wherein the positioning measurements are associated with a validity time, upon expiry of which the positioning measurements are considered invalid.

45. The method according to claim 44, wherein a validity timer corresponding to the validity time is started upon:
the UE performing a positioning measurement;
upon reception of the first message by the UE; or
upon transmission of the first message by the network node.

46. The method according to claim 44, wherein the one or more instructions comprise an instruction to perform one or more positioning measurements based on an amount of time remaining of the validity time.

47. The method according to claim 39, wherein the one or more instructions are based on information reported by the UE to the network node.

48. The method according to claim 39, wherein the UE is a narrow band Internet-of-things (NB-IoT) device or an enhanced machine type communication device, and the NTN is an IoT NTN or a New Radio (NR) NTN.

49. A method performed by a network node in a non-terrestrial network (NTN) for determining a timing advance, the method comprising:
transmitting, to a user equipment (UE) in the NTN, a first message comprising one or more instructions configuring the UE to perform positioning measurements, wherein the positioning measurements indicate a location of the UE for use in determining the timing advance.

50. The method according to claim 49, the method further comprising transmitting, to the UE, a timing advance adjustment.

51. The method according to claim 49, the method further comprising transmitting, to the UE, an indication of one or more periods of time in which the network node is to refrain from transmitting downlink transmissions to the UE.

52. The method according to claim 51, wherein the one or more periods are for the UE to perform one or more positioning measurements.

53. The method according to claim 49, wherein the positioning measurements are associated with a validity time, upon expiry of which the positioning measurements are considered invalid.

54. The method according to claim 53, wherein a validity timer corresponding to the validity time is started upon:
the UE performing a positioning measurement;
reception of the first message by the UE; or
upon transmission of the first message by the network node.

55. The method according to claim 53, wherein the one or more instructions comprise an instruction to perform one or more positioning measurements based on an amount of time remaining of the validity time.

56. The method according to claim 49, wherein:
the network node is located on a non-terrestrial satellite and forwards data between the UE and a terrestrial-based network node; or
the network node is terrestrial-based and receives data from a network node located on a non-terrestrial satellite forwarding data between the UE and the network node.

57. A user equipment (UE) configured for operation with a non-terrestrial network (NTN), the UE comprising:
a communication interface; and
processing circuitry configured to cause the UE to:
receive, via the communication interface, a first message from a network node of the NTN, the first message comprising one or more instructions configuring the UE to perform positioning measurements, wherein the positioning measurements indicate a location of the UE for use in determining a timing advance; and
power supply circuitry configured to supply power to the processing circuitry.

58. A network node in a non-terrestrial network (NTN), for determining a timing advance, the network node comprising:
a communication interface; and
processing circuitry configured to cause the network node to:
transmit, via the communication interface, a first message to a user equipment (UE), the first message comprising one or more instructions configuring the UE to perform positioning measurements, wherein the positioning measurements indicate a location of the UE for use in determining the timing advance; and
power supply circuitry configured to supply power to the processing circuitry.
